(19) United States
(12) Patent Application Publication
(10) Pub. No.: US 2013/0158969 A1
(43) Pub. Date: Jun. 20, 2013

(54) Method and Apparatus for Non-Invasive Blood Pressure Simulation

(71) Applicants: Robert F. Donehoo, Colgate, WI (US); Dennis Sauer, Round Lake, IL (US); Stephen Kobs, Jackson, WI (US)

(72) Inventors: Robert F. Donehoo, Colgate, WI (US); Dennis Sauer, Round Lake, IL (US); Stephen Kobs, Jackson, WI (US)

(73) Assignee: GENERAL ELECTRIC COMPANY, Schenectady, NY (US)

(21) Appl. No.: 13/331,578

(22) Filed: Dec. 20, 2011

(51) Int. Cl. G06G 7/60

(52) U.S. Cl. 703/11

(57) ABSTRACT

An apparatus and method of non-invasive blood pressure simulation uses a processor to calculate at least one transitory blood pressure envelope between an initial envelope representing an initial blood pressure and a final envelope representing a final blood pressure. The processor operates a pressure generator to create oscillatory pulse calculated by the processor from the at least one transitory envelope.

### BACKGROUND

The present disclosure is related to the field of non-invasive blood pressure monitoring. More specifically, the present disclosure is related to the simulation of conditions from which non-invasive blood pressure may be determined.

Non-invasive blood pressure (NIBP) determination uses a flexible inflatable and deflatable cuff that occludes a brachial artery of a patient when fully inflated. The NIBP device selectively inflates and deflates the cuff and a pressure transducer pneumatically coupled to the cuff senses the pressure therein.

Blood pressure of the patient can be determined by analyzing the signal off of the pressure transducer using oscillometric techniques. Due to the compliant properties of the blood vessels, pressure oscillations in the artery caused by a heart beat results in small cyclical volume changes in the artery. These small volume changes in the artery are transferred to the inflated cuff wrapped around the limb and finally result in small pressure changes in the cuff. These cuff pressure oscillations are found in the signal produced by the pressure transducer and can be analyzed by an NIBP device in order to non-invasively determine the systolic pressure, diastolic pressure, and mean arterial pressure (MAP) of the patient.

In addition to an NIBP device, it is desirable to have an NIBP simulator that mimics the conditions detected by an NIBP device when an NIBP device is used on a patient. The simulator is used with an NIBP device in laboratory or clinical settings in order to test, maintain, or calibrate NIBP devices. The testing, maintenance, or calibration of NIBP device may be performed in a variety of contexts including product development, product manufacturing quality control, or on-going maintenance or quality assurance of NIBP devices used in the field.

### BRIEF DISCLOSURE

An embodiment of a non-invasive blood pressure simulation device includes a user input device. A processor operates to calculate a transient envelope from at least one initial blood pressure value and at least one final blood pressure value. The processor calculates a plurality of oscillometric pulse pressure from the transient envelope. A pressure generator is operated by the processor to produce a plurality of oscillometric pulses.

A method of simulating a non-invasive blood pressure measurement includes calculating an initial envelope from at least one initial blood pressure value. A final envelope is calculated from at least one final blood pressure value. A transitory envelope is calculated from the first envelope and the second envelope. Oscillatory pulses are calculated from the transitory envelope. A pressure generator is operated to create the oscillatory pulses within a blood pressure measurement cuff.

### BRIEF DESCRIPTION OF THE DRAWINGS

FIG. 1 is a system diagram of an NIBP simulator and NIBP device.

FIG. 2 is a graph that depicts detected and calculated values associated with NIBP.

FIG. 3A is a graph that depicts an initial envelope, a final envelope, and a transitory envelope.

FIG. 3B is a graph that depicts a plurality of envelopes over the progression of an exemplary NIBP simulation.

FIG. 4 is a graph that depicts exemplary pressures detected within a blood pressure cuff.

FIG. 5 is a flow chart depicting an embodiment of a method of simulating a non-invasive blood pressure measurement.

### DETAILED DISCLOSURE

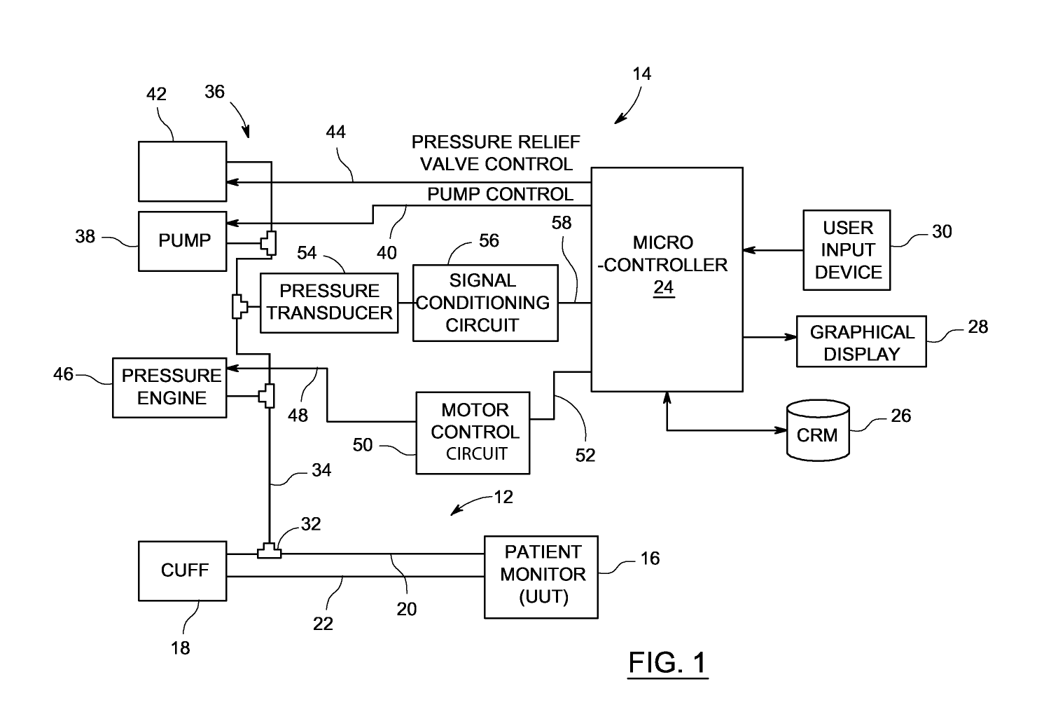

FIG. 1 depicts a blood pressure simulation and measuring system 10 which includes a non-invasive blood pressure (NIBP) monitoring device 12 and an NIBP simulation device 14.

The NIBP monitoring device 12 includes the patient monitor 16, that while not depicted, incorporates a pressure transducer, microprocessor, a source of pressurized air, an inflate valve and a deflate valve such as is operable to automatedly determine the blood pressure of a patient using NIBP calculation techniques. An inflatable cuff 18 is pneumatically connected to the patient monitor 16 by an inflation duct 20 and an exhaust duct 22. The patient monitor 16 provides pressure to the cuff 18 through the inflation duct 20 and systematically removes pressure from the cuff 18 through the exhaust duct 22 in a plurality of pressure steps, such as is known in NIBP determinations of patient blood pressure.

The NIBP simulation device 14 includes a microcontroller 24 that operates computer readable code stored on a computer readable medium 26 in order to carry out the functions as described herein. The computer readable medium 26 may be any of a variety of volatile or non-volatile memory, including, but not limited to flash memory. In embodiments, the computer readable medium 26 may be integrated into the microcontroller 24 (not depicted), or as depicted, the computer readable medium 26 may be a separate component that is communicatively connected to the microcontroller 24. In either embodiment, the microcontroller 24 executes the computer readable code stored on the computer readable medium 26 in order to operate to carry out the processing and control functions as disclosed herein.

A graphical display 28 and a user input device 30 are communicatively connected to the microcontroller 24. The graphical display 28 and the user input device 30 provide the user interface to the clinician or technician using the NIBP simulation device 14. The clinician or technician using the NIBP simulation device 14 can view prompts or other data by the graphical display and enter input values or other commands, as described herein, to the NIBP simulation device 14 through the user input device 30. In an exemplary embodiment, the user input device 30 is a keyboard, touch screen, or a mouse; however, these are not intended to be limiting on the scope of user input devices 30 that may be used within the scope of the disclosed NIBP simulation device 14.

The NIBP simulation device 14 is connected to the NIBP monitoring device 12 with a T-connection 32. More specifically, the T-connection 32 pneumatically connects the inflation duct 20 of the NIBP monitoring device 12 to an oscillation duct 34 of the NIBP simulation device 14. The oscillation duct 34 provides a backbone to a pneumatic system 36 of the NIBP simulation device 14. A pump 38 is pneumatically connected to the oscillation duct 34. The pump 38 is operated by the microcontroller 24 via a pump control signal 40 in order to generate an oscillation pressure as will be disclosed in further detail herein. An exhaust valve 42 is further pneumatically connected to the oscillation duct 34. The exhaust valve 42 is operated with a pressure relief signal 44 from the microcontroller in order to selectively remove pressure from the pneumatic system 36.

A pressure engine 46 is further pneumatically connected to the oscillation duct 34. The pressure engine 46 operates to create pressure oscillations as defined by the microcontroller 24 in the cuff 18 to which the pressure engine 46 is pneumatically connected via the oscillation duct 34, T-connector 32, and inflation duct 20. In one embodiment, the pressure engine 46 includes a motor (not depicted) and a diaphragm (not depicted) that is operated by the motor. Oscillations of the diaphragm within the pressure engine 46 as controlled by the motor produce changes in the volume of the oscillation duct 34, resulting in pressure oscillations in the inflatable cuff 18. While the pressure engine 46 has been described above as incorporating a motor and a diaphragm, it is to be understood that this is merely an exemplary embodiment of one implementation of such a pressure engine 46, and not intended to be limiting upon the type of pressure engines 46 that may be implemented with alternative embodiments by a person of ordinary skill in the art while remaining within the scope of the present disclosure.

In the embodiment of the NIBP simulation device 14, the pressure engine is operated by a motor control signal 48 by a motor control circuit 50. In one embodiment, the motor control circuit 50 is a motor encoder. The motor control circuit 50 receives instructions from the microcontroller on a motor control bus 52.

A pressure transducer 54 is both pneumatically connected to the oscillation duct 34 and electronically connected to the microcontroller 24. Embodiments of the pressure transducer 54 may be any of a variety of pressure transducers as known to a person of ordinary skill in the art. The pressure transducer 54 is electrically connected to a signal conditioning circuit 56 which provides a pressure input signal 58 to the microcontroller 24. As will be described in further detail herein, the pressure input signal 58 is used by the microcontroller 24 to monitor the pressure in the inflatable cuff 18 as determined by the NIBP monitoring device 12.

As will be explained in further detail herein, the microcontroller 24 receives user inputs from the user input device 30 representative of the blood pressure condition of the patient to be simulated. In an embodiment, the NIBP simulation device 14 receives indications of the blood pressure, namely systolic, diastolic, or mean arterial pressure that are to be measured by the NIBP monitoring device 12. The NIBP simulation device 14 may further receive an indication of a heart rate to be simulated. The microcontroller executes computer readable codes stored on the computer readable medium 26 in order to calculate the pressure oscillations to be created by the pressure engine 46 and pump 38, that when detected by the patient monitor 16, should result in the patient monitor 16 arriving at the same blood pressure and heart rate that were input by the clinician or technician into the NIBP simulation device 14. The oscillation duct 34 and the T-connection 32 pneumatically connect the pneumatic system 36 of the NIBP simulation device 14 to the cuff 18 of the NIBP monitoring device 12 such that the patient monitor 16 of the NIBP monitoring device will detect the generated pressure oscillation.

By comparing the pressure and heart rate input into the NIBP simulation device and the measured blood pressure and heart rate values provided by the NIBP monitoring device 12, and evaluation of the operation of the NIBP monitoring device 12 can be made in order to test, maintain, or calibrate the NIBP monitoring device 12.

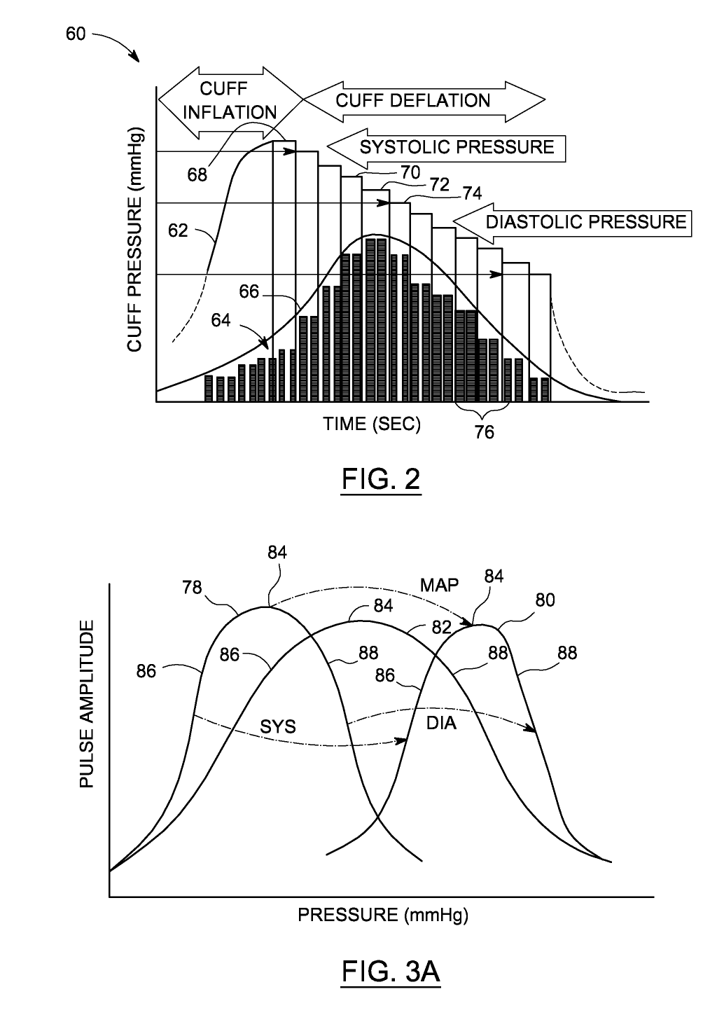

FIG. 2 is a graph that depicts exemplary waveforms for a normal oscillometric non-invasive blood pressure determination with the amplitude of oscillometric pulses gathered at different cuff pressures. Multiple waveforms are depicted in FIG. 2. Curve 62 represents the overall pressure within the inflatable cuff. Bars 64 represent the measured pulse amplitudes for each oscillometric pulse at various cuff pressures over the time of the blood pressure determination procedure. The curve 62 and the bars 64 are used to calculate an oscillation amplitude versus cuff pressure curve, which is known as an oscillometric envelope 66. As shown in the graph 60 of FIG. 2, the cuff is first inflated to a supra-systolic pressure, indicated as reference 68 on curve 62. The cuff pressure is then reduced in a series of small incremental steps, exemplarily steps 70, 72, and 74. Cuff pressure oscillation 76 corresponds to each pulse and are measured at each incremental cuff pressure. The peak pulse amplitudes (PPA) of each oscillation increase with each decrement of cuff pressure until the PPA reaches a maximum at the cuff pressure step 72. The PPA diminishes with every subsequent reduction in cuff pressure. Thus, the cuff pressure at 72 represents the patient's mean arterial pressure (MAP), and the patient's systolic and diastolic pressures can be determined therefrom. The amplitudes of the oscillations at the systolic and diastolic pressures may be computed by taking a percentage of the oscillation amplitude at the MAP. In this manner, the systolic data point and diastolic data point along the fitted curve may be computed and their respective pressures may be estimated therefrom.

NIBP simulation operates in a manner that is substantially reverse of NIBP measurement. In NIBP simulation, the simulator receives inputs in an amount of heart rate to simulate, and the blood pressure value, namely systolic pressure, diastolic pressure, and MAP. From these pressure values, an envelope is derived and resulting pressure oscillations for each incremental pressure step are determined based upon the calculated envelope and the simulated heart rate.

NIBP measurement made by an NIBP monitoring device can be limited in that the process as described above assumes that the patient's blood pressure stays constant over the course of the generally 15-120 seconds required for an NIBP determination. This assumption can introduce error into NIBP measurements, particularly when blood pressure is determined during times of rapid change in blood pressure. Blood pressure can change quickly during many medical conditions, particularly those medical conditions as seen with critical care patients. Changes in blood pressure can result from a loss of blood or other fluid, the introduction of drug or anesthesia, or in response to a physiological condition or pathology. As one specific example, a patient's blood pressure can rapidly change when a patient undergoes an inducement phase of anesthesia.

NIBP simulation of these conditions can be made more realistic by simulating a changing blood pressure during the course of an NIBP measurement. As noted above, without a variable blood pressure this is not an accurate simulation of the physiological condition experienced by a patient in a variety of clinical settings. Therefore, the NIBP simulator as disclosed herein provides the feature of a variable simulated blood pressure.

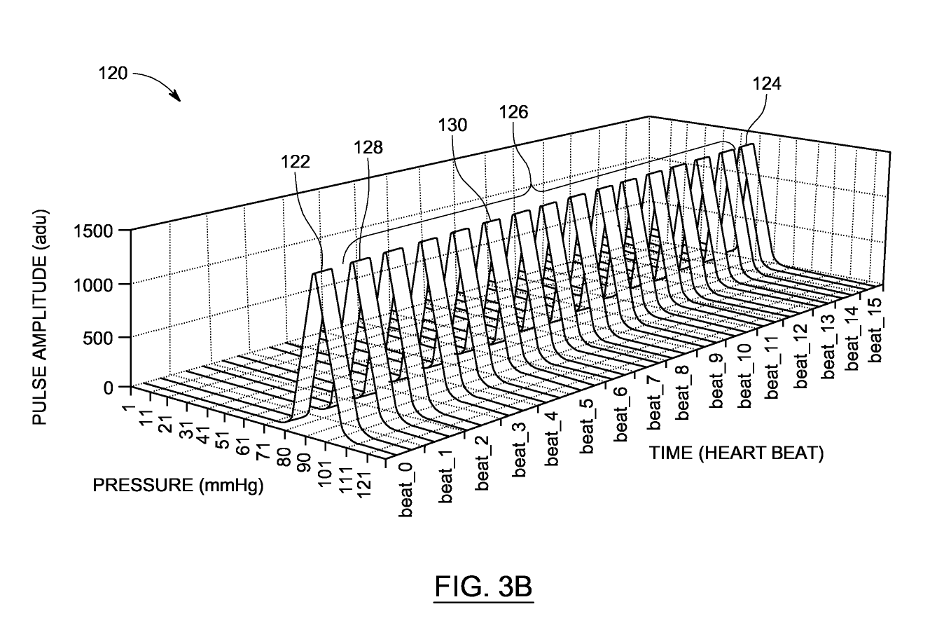

FIG. 3A is a graph that depicts exemplary embodiments of various envelopes as used within the present disclosure. As noted above, the envelopes are created by fitting a curve to a graph of oscillometric pulse amplitude (Y-axis) versus cuff pressure (X-axis). As further noted above, some techniques for NIBP determination decrease the pressure within the inflatable cuff in a step wise manner while other techniques continuously release pressure from the cuff A person of ordinary skill in the art will recognize the differences in envelope calculation methods based upon these two different NIBP determination techniques.

The graph of FIG. 3A includes three envelopes as will be described in further detail herein. Namely, an initial envelope 78, a final envelope 80, and a transitory envelope 82. As discussed above, the NIBP simulation device receives input blood pressure values to create one or more envelopes and then derives the individual pressure oscillations from the one or more envelopes. Each envelope has three representative components. The envelope peak 84 represents the MAP, the rising side 86 of the envelope represents the systolic pressure, and the falling side 88 represents the diastolic pressure. The transitory envelope 82 is created as disclosed herein from the initial envelope and the final envelope 80 to represent a change in simulated blood pressure occurring at a particular point in time during the course of the blood pressure determination. While a single transitory envelope 82 is depicted, it will be recognized as disclosed herein that alternative embodiments may use one or more transitory envelopes over the course of the NIBP simulation to make the transition from the initial envelope 78 to the final envelope 80.

In the NIBP simulation, an initial systolic pressure, diastolic pressure, and MAP are provided by the clinician or technician to represent the blood pressure to be simulated at the start of the NIBP simulation. The initial envelope 78 is derived from these initial input values. Final systolic pressure, diastolic pressure, and MAP values are also input to represent the blood pressure to be simulated at the end of the NIBP simulation. The received final systolic, diastolic, and MAP values are used to derive the final envelope 80. As will be disclosed in further detail herein, the initial envelope 78 and the final envelope 80 are combined using one of a variety of transfer functions to create at least one transitory envelope 82 which is used by the NIBP simulation device to simulate a patient's blood pressure at a particular point in time between the start and the end of the simulation. As will be disclosed in further detail herein, an input value for pulse rate or rhythm is also provided to identify how often an oscillation is to be generated.

As disclosed above, embodiments of the NIBP simulation use one or more transitory envelopes for the NIBP simulation between the initial envelope and the final envelope. The number of transitory envelopes used in a simulation may be dependent upon the duration of the simulation either as measured by time or by heart beats. If the simulation duration is known either in terms of time or heart beats, then a number of transitory envelopes can be calculated to provide the transition from the initial envelope to the final envelope according to the transfer function. The transitory envelopes can therefore be used for a particular duration of time or number or beats within the simulation. If the simulation duration is not known, then a time for the final envelope can be used and a selected number of transitory envelopes are used on an incremental time basis from the time of the initial envelope until the time of the final envelope. If the NIBP simulation lasts beyond the time of the final envelope, then the NIBP simulation is performed for the remainder of the simulation using the final envelope.

The transfer functions used to calculate transitory envelope 82 from the initial envelope 78 and the final envelope 80 can include, but are not limited to, linear, exponential, or logarithmic transfer functions. Such transfer functions define the progression of the transitory envelope 82 from the blood pressure as represented by the initial envelope 78 to the blood pressure as represented by the final envelope 80. The transfer function contains both a mathematical representation and a time relationship to the transition from the initial to the final envelope. The transitory envelope 82 can be calculated on a heart beat by heart beat basis according to the transfer function. Thus, the transitory envelope 82 would progressively become more closely representative of the final envelope 80 with each simulated beat of the blood pressure simulation. The selected transfer function determines the progression of the transition from the initial envelope to the final envelope by the transitory envelope. Therefore, if a linear transfer function is used, each heart beat will bring the transitory envelope closer into alignment with the final envelope by an even amount with each beat. If an exponential transfer function is used, then the transitory envelope will transition between the initial envelope and the final envelope exponentially with each new heart beat of the simulation. If a logarithmic transfer function is selected, in which case, the transitory envelope 82 would substantially align with the final envelope after relatively few simulated heart beats. Thus, a selection of the proper transfer function can be important in accurately representing the manner in which the simulated blood pressure changes over the course of the NIBP determination.

FIG. 3B is a graph 120 that depicts a plurality of exemplary envelopes over the progression of an exemplary NIBP simulation. The specific envelope values and number of envelopes depicted in graph 120 are merely exemplary and are not intended to be limiting on the NIBP simulations as disclosed herein. The graph 120 shows the progression of a NIBP simulation starting with a given initial envelope 122 associated with Beat 0 and a given final envelope 124 associated with Beat 15. As noted, the number of beats over the simulation is non-limiting and merely for description purposes, as would be recognized by one of ordinary skill in the art. A plurality of transitory envelopes 126 represent the beats between the initial envelope 122 and the final envelope, exemplary envelope 128 and envelope 130. The NIBP simulation is started when pressure is first sensed by the pressure transducer 54 (FIG. 1). At this point the initial envelope 120 creates the oscillation amplitude for the pressure pulse of Beat 0. The user input value for pulse rate is then used along with the transfer function to calculate the next transitory envelope 128. As time progresses additional transitory envelopes (e.g. 130) in the plurality of envelopes 126 are calculated for each pressure pulse generated for successive heart beats. This continues until the final envelope 124 is reached, at which point there are no further changes to the envelope used for the simulation.

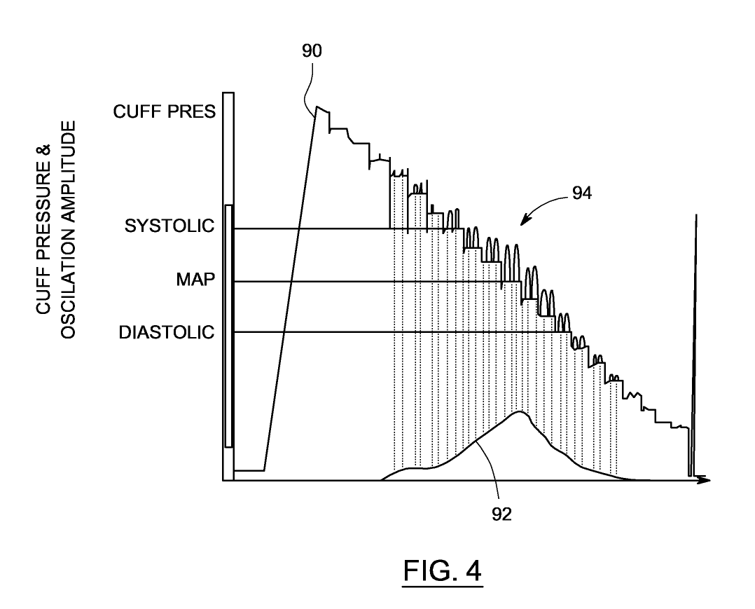

FIG. 4 is a graph that depicts cuff pressure 90 which may be sensed by pressure transducer 54 (FIG. 1) and the transitory envelope 92 as used by the NIBP simulation device to create the pressure oscillations 94 that will be detected by the NIBP monitoring device being evaluated in the simulation. As will be described further herein, the pressure transducer can detect the base pressure in the cuff as established by the NIBP monitoring device. The NIBP simulation device uses the detected cuff pressure 90 and the calculated transitory envelope 92 to calculate the pressure oscillation 94 in conjunction with each simulated heart beat at each cuff pressure step in order to be representative of the patient blood pressure to be simulated. An established heart rate, which is either a default value or has been entered by a clinician or technician into the NIBP simulation device, is used to determine when the pressure oscillations occur during the NIBP simulation.

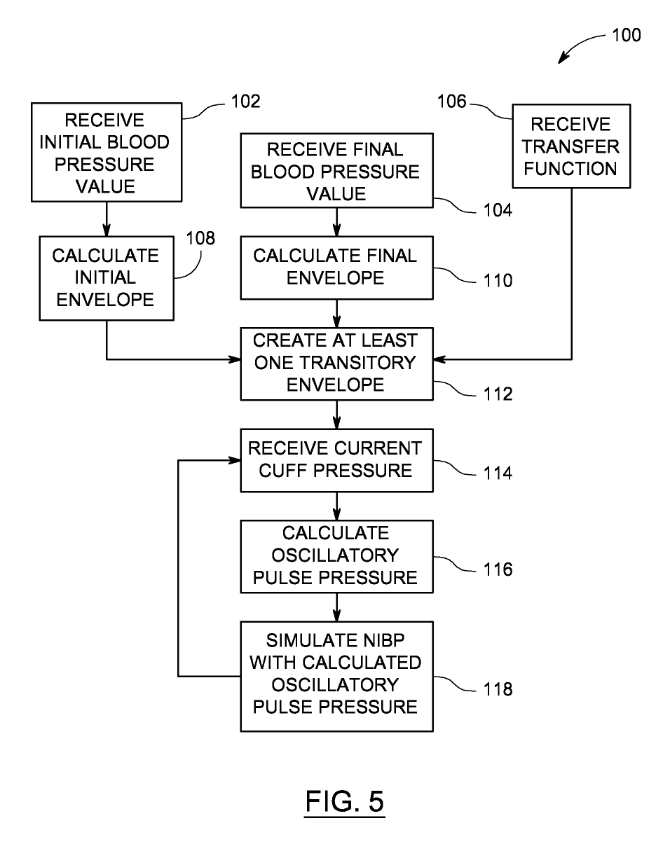

FIG. 5 is a flow chart that depicts an embodiment of a method 100 of simulating an NIBP measurement. The description of the method 100 will include references to previously described FIGS. 1-4. The method 100 begins with receiving one or more inputs or starting values, exemplarily from a clinician or technician using the user input device. It is to be understood that alternative input methods can be used, including the transfer of data to the NIBP simulation device via an electronic data communication connection. The NIBP simulation device receives at least one initial blood pressure value 102 and at least one final blood pressure value 104. It is to be understood that such initial blood pressure values and final blood pressure values may include some or all of initial systolic pressure, diastolic pressure, and MAP values and similarly may include some or all of final systolic pressure, diastolic pressure, and MAP values. Additionally, a transfer function is received by the NIBP simulator at 106. More specifically, the microcontroller of the NIBP simulator receives the transfer function. The transfer function received at 106 may be a default transfer function stored on a computer readable medium in communication with the microcontroller. Upon commencement of the NIBP simulation, the microcontroller receives the transfer function from the computer readable medium. In alternative embodiments, the transfer function received at 106 may be a transfer function that is input by the clinician or technician using the user input device. In still further embodiments, the transfer function received at 106 may be a selection of one of a plurality of transfer functions that are stored on a computer readable medium, and in such embodiments, the microcontroller may cause one or more indications of the available transfer functions to be presented on the graphical display and a clinician or technician performing the NIBP simulation can select a transfer function from this presentation, the microcontroller receiving this selection of the transfer function.

In additional embodiments, a pulse amplitude input is also received. The pulse amplitude input may be a constant or fixed value, may be a progressive series of values, or may be an equation that defines the pulse amplitudes throughout the NIBP simulation. The pulse amplitude input is used in conjunction with the received blood pressure values and/or transfer function in creating the initial envelope, final envelope, and transitory envelopes as disclosed herein. In still further embodiments, an input representative of the simulated pulses is received. The input that represents the simulated pulses can impact the manner in which other features of the method are carried out. More specifically, if the simulated pulses are to remain constant or regular throughout the NIBP simulation, then a single determination of pulse rate can be used to pre-calculate all of the transitory envelopes, as described in further detail herein. If the pulse input is irregular, or namely changes during the NIBP simulation and is therefore defined by an algorithm itself, then this pulse train formula must be solved for each transitory envelope to be created for the simulation.

At 108 an initial envelope is calculated from the at least one initial blood pressure value received at 102. As depicted in FIG. 3, the systolic pressure, diastolic pressure, and MAP values are each associated with a particular features of the initial envelope. Therefore, in some embodiments, the initial systolic pressure, diastolic pressure, and MAP are all used at 108. Similarly, at 110 the at least one final blood pressure value received at 104 is used to calculate a final envelope. In some embodiments, the final systolic pressure, diastolic pressure, and MAP are all used at 110. At least one of the received initial blood pressure values and final blood pressure values are different, thus creating a situation wherein the simulated final blood pressure is different from the simulated initial blood pressure. These differences between the initial and final blood pressures are reflected in the initial and final envelopes. The initial envelope calculated at 108 and the final envelope calculated at 110 can be calculated using known methods that are the reverse of those used in the NIBP determination of systolic pressure, diastolic pressure, and MAP values from measured pressure oscillation envelopes. As disclosed above, the initial and final envelopes may be calculated using further inputs in addition to the received blood pressure values, including, but not limited to, a pulse amplitude and a pulse rate/rhythm.

Next at 112, the transfer function received at 106 is applied to the initial envelope calculated at 108 and the final envelope calculated at 110 in order to create at least one transitory envelope. As previously described above, the at least one transitory envelope created at 112 is dependent on the initial envelope, final envelope, and transfer function. Additionally, the manner in which those three components are combined to create the at least one transitory envelope, will have an effect on the resulting NIBP simulation. As disclosed above, the number of transitory envelopes used can vary simulation to simulation as each transitory envelope can be associated with a particular number of heart beats in the simulation or each transitory envelope can be associated with a time duration within the simulation. In one embodiment, the number of transitory envelopes used in the simulation is based upon a determined resolution for following, or defined by, the transfer function.

In one embodiment, the pressure transducer 54 of the NIBP simulation system measures the cuff pressure created by the NIBP measurement device and the transitory envelope is calculated for each simulated heart beat based upon the associated pulse amplitude for the detected cuff pressure, as is shown in the graph of FIG. 4. Because the embodiment for creating the transitory envelope that relies upon the cuff pressure requires an intra-simulation measurement, the transitory envelope is created at 112 on a heart beat by heart beat basis. This embodiment of the method can be exemplary used when the pulse rhythm is not regularly periodic in time such as would be provided during a simulation of atrial fibrillation.

In an alternative embodiment, a heart rate for the simulation may be previously established either by default or by user input and this can be combined with a similarly established simulation duration that also may be established by default or by user input. The heart rate and simulation duration can be combined to determine a number of heart beats for the entire NIBP simulation and therefore the initial envelope, final envelope, and transitory envelope can be divided into even segments representative of each heart beat during the simulation. Therefore, since the transitory envelope is calculated based upon a predetermined heart rate and predetermined simulation duration, in this embodiment, the entire transitory envelope progression can be calculated at once at 112 as shown in FIG. 3B.

At 114, the pressure transducer 54 of the NIBIP simulation system measures the current cuff pressure created by the NIBP measurement device. This measured current cuff pressure is received and is used at 116 to calculate an oscillatory pulse pressure to represent the current heart beat in the simulation. This calculation is performed at 116 by selecting the transitory envelope 112 to be used for the current heat beat duration in the simulation and the measured current cuff pressure is applied to the selected transitory envelope.

The NIBP simulation device, particularly the pneumatic system of the NIBP simulation device is used at 118 to create the oscillatory component calculated at 116 and apply that calculated oscillatory component to the inflatable cuff of the NIBP monitoring device to simulate the current heart beat. The measurement of the current cuff pressure at 114, calculation of the oscillatory pulse pressure at 116, and the creation of the oscillatory pressure component in the inflatable cuff at 118 are repeated for each simulated heart beat until the NIBP simulation procedure is complete. The NIBP monitoring device detects each of the simulated oscillatory pressure components and calculates one or more blood pressure values from the NIBP simulation.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A non-invasive blood pressure (NIBP) simulation device comprising:
a user input device configured to receive at least one initial blood pressure value and at least one final blood pressure value;
a processor that operates to calculate at least one transitory envelope from the at least one initial blood pressure value and the at least one final blood pressure value, and the processor calculates a plurality of oscillometric pulse pressures from the at least one transitory envelope; and
a pressure generator operated by the processor to produce oscillometric pulses at the plurality of oscillometric pulse pressures.

2. The device of claim 1, wherein the at least one initial blood pressure value represents an instantaneous blood pressure envelope at a start of an NIBP simulation and the at least one final blood pressure value represents an instantaneous blood pressure envelope at an end of the NIBP simulation.

3. The device of claim 2, wherein the at least one initial blood pressure value comprises an initial mean arterial pressure, an initial systolic pressure, and an initial diastolic pressure, and the at least one final blood pressure value comprises a final mean arterial pressure, a final systolic pressure, and a final diastolic pressure; and
wherein at least one of the initial mean arterial pressure, initial systolic pressure, and initial diastolic pressure is different from at least one of the final mean arterial pressure, final systolic pressure, and final diastolic pressure, respectively.

4. The device of claim 1, wherein the processor calculates an initial envelope from the at least one initial blood pressure value and calculates a final envelope from the at least one final blood pressure value, the processor further calculates the at least one transitory envelope from the initial envelope and the final envelope.

5. The device of claim 4, further comprising:
a non-transient computer readable medium communicatively connected to the processor, wherein a transfer function is stored on the non-transient computer readable medium;
wherein the at least one transitory envelope is a plurality of transitory envelopes and the processor calculates the plurality of transitory envelopes from the initial envelope, the final envelope, and the transfer function.

6. The device of claim 5, wherein the processor receives a simulation duration defined as a number of simulated heart beats and each transitory envelope of the plurality represents a predetermined number of simulated heart beats.

7. The device of claim 5, wherein the processor receives a simulation duration defined as a simulation time between the initial blood pressure and the final blood pressure and each transitory envelope of the plurality is associated to a predetermined time duration within the NIBP simulation.

8. The device of claim 5, wherein the processor receives an indication of a simulated pulse and the processor further calculates the plurality of transitory envelopes using the indication of the simulated pulse.

9. The device of claim 5, wherein the transfer function comprises a transfer function selected from a linear transfer function, an exponential transfer function, and a logarithmic transfer function.

10. The device of claim 5, wherein the processor receives a number of heart beats for an NIBP simulation, and the processor sequentially calculates the plurality of transient envelopes for each heart beat in the simulation.

11. The device of claim 10, wherein the processor calculates an oscillometric pulse of the plurality of oscillometric pulses from each transient envelope of the plurality to simulate a heart beat represented by the transient envelope.

12. The device of claim 11, further comprising a pressure transducer pneumatically connected to an inflatable cuff, wherein the pressure transducer provides a measurement of current cuff pressure to the processor and the processor calculates the oscillometric pulse from the current cuff pressure and the transient envelope of the plurality.

13. A method of simulating a non-invasive blood pressure (NIBP) measurement, the method comprising:
calculating a first envelope from at least one initial blood pressure value with a processor;
calculating a second envelope from at least one final blood pressure value with the processor;
calculating, with the processor, at least one transitory envelope from the first envelope, the second envelope, and a transfer function;
calculating oscillatory pulses from the at least one transitory envelope; and
operating a pressure generator to create the oscillatory pulses within an inflatable cuff.

14. The method of claim 13, further comprising:
receiving, with the processor, the at least one initial blood pressure value from a user input device; and
receiving, with the processor, the at least one final blood pressure value from the user input device;
wherein the at least one initial blood pressure value comprises an initial mean arterial pressure, an initial systolic pressure, and an initial diastolic pressure and the at least one final blood pressure value comprises a final mean arterial pressure, a final systolic pressure, and a final diastolic pressure; and
wherein the at least one of the initial blood pressure values and at least one of the final blood pressure values are different.

15. The method of claim 13, further comprising:
measuring a pressure within the inflatable cuff with a pressure and transducer pneumatically connected to the inflatable cuff;
providing the measured pressure to the processor; and
calculating an oscillatory pulse with the processor by applying the measured pressure to the at least one transitory envelope.

16. The method of claim 13, wherein the at least one transitory envelope is a plurality of transitory envelopes and each transitory envelope of the plurality is associated with a duration within the NIBP simulation between the initial blood pressure value and the final blood pressure value.

17. The method of claim 16, further comprising:
receiving an indication of a simulated pulse with the processor; and
calculating the plurality of transitory envelopes with the processor using the transfer function and the indication of the simulated pulse.

18. A non-invasive blood pressure (NIBP) simulation device comprising:
a user input device configured to receive initial blood pressure values and final blood pressure values;
a processor that operates to calculate an initial envelope from the initial blood pressure values and a final envelope from the final blood pressure values, wherein the processor further calculates at least one transitory envelope using a transfer function applied to the initial envelope and the final envelope;
a pressure transducer configured t pneumatically connect to an NIBP measurement cuff, measure a current pressure in the NIBP measurement cuff and provide the measured current pressure to the processor; and
a pressure generator operated by the processor to create an oscillometric pulse in the NIBP measurement cuff, wherein a pulse pressure of the oscillometric pulse is calculated by the processor using the current pressure in the NIBP measurement cuff and the at least one transitory envelope.

19. The device of claim 18, wherein the processor receives an indication of a simulated pulse and the processor calculates a plurality of sequential transitory envelopes between the initial envelope and the final envelope using the transfer function and the indication of the simulated pulse.

20. The device of claim 19, wherein the indication of the simulated pulse includes a predetermined number of simulated heart beats and the processor calculates a transitory envelope for each of the predetermined number of simulated heart beats.
